(19) United States
(12) Patent Application Publication
(10) Pub. No.: US 2008/0188117 A1
(43) Pub. Date: Aug. 7, 2008

(54) Electrical adapter box within improved fastening structure

(75) Inventors: Peter Kuo, Tu-Cheng (TW); Hou-Yu Shi, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/012,850

(22) Filed: Feb. 6, 2008

(30) Foreign Application Priority Data
Feb. 7, 2007 (CN) 200720034634.4

(51) Int. Cl. H01R 13/62

(52) U.S. Cl. 439/367

(57) ABSTRACT

An electrical adapter box comprises a combined cover comprising a first upper cover and a second lower cover, a main body comprising receiving space to receive some electric connectors and some posts, and a fastening portion comprising a pushing portion whose touching face faces to the exterior of the electrical adapter box, a first rib assembling the combined cover without outside force and an axis be supported by said posts; wherein the first and second cover respectively have a cutout, said two cutout correspond to each other, and said fastening portion removes with a pivot formed by said axis under outside force.

### BACKGROUND OF THE INVENTION

1. Field of the Invention

The present invention relates generally to an electrical adapter box, and more particularly to an electrical adapter box used as a external element to connect a mobile electronic device.

2. Description of the Prior Art

At present, most audio/video electronic devices connect the mating connectors by their electric connectors. The electronic devices are need to be charged and transfer signals to other devices. For the limitation of the volume of the electronic device, an electrical adapter box is needed to provide a bridge to connect the electronic device to some other different electric connectors with different mating connectors. FIG. 1 shows an electrical adapter box with two different upper covers. The two covers respectively have a receiving space and the receiving spaces have different shapes to each other to adapt to different electronic devices. The electronic device comprises a first cover 101′, a second cover 102′, base body 103′ and a fastening portion 104′ connecting the first cover 101′ and the second cover 102′. One end of the fastening portion 104′ connects the second cover 102′, and the joint of the fastening portion 104′ and the second cover 102′ is melted so that the fastening portion 104′ and the second cover 102′ can be assembly together. And the other end of the fastening portion 104′ movably assembles the first cover 101′ and the second cover 102′. When the fastening portion 104′ is forced by outside force, the first cover 101′ could be apart from the second cover 102′. However, the fastening portion 104′ can not help the assembly between the first cover 101′ and the second cover 102′ and the assembly is not fast enough and simple-disconnecting.

Hence, an improved electrical adapter box with improved fastening structure is desired to overcome the above-mentioned shortcomings of the existing antennas.

### BRIEF SUMMARY OF THE INVENTION

A primary object, therefore, of the present invention is to provide an electrical adapter box which is able to be assembled and disassembled more convenient.

In order to implement the above object and overcomes the above-identified deficiencies in the prior art, the electrical adapter box comprises a combined cover comprising a first upper cover and a second lower cover, a main body comprising receiving space to receive some electric connectors and some posts, and a fastening portion comprising a pushing portion whose touching face faces to the exterior of the electrical adapter box, a first rib assembling the combined cover without outside force and an axis be supported by said posts; wherein the first and second cover respectively have a cutout, said two cutout correspond to each other, and said fastening portion removes with a pivot formed by said axis under outside force.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a conventional electrical adapter box with a fastening structure;

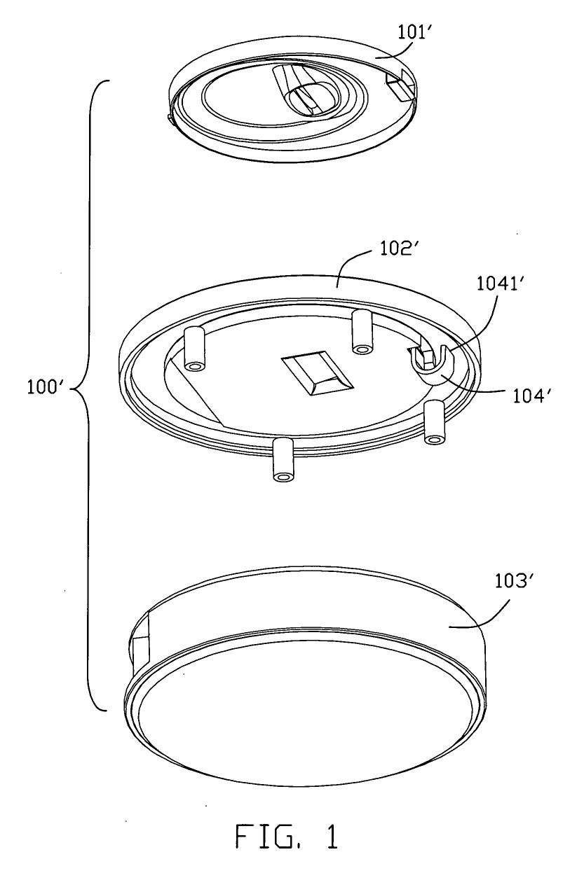

FIG. 2 is a perspective view illustrating a fastening element according to a preferred embodiment of the present invention;

FIG. 3 is a perspective view similar to FIG. 2, but viewed from another angle;

FIG. 4 is a perspective view illustrating an electrical adapter box according to a preferred embodiment of the present invention;

FIG. 5 is a exploded, perspective view of FIG. 4;

FIG. 6 is a perspective view illustrating a part of the electrical adapter box according to a preferred embodiment of the present invention; and

FIG. 7 is a cross-section view taken along line 7-7 of FIG. 4.

### DETAILED DESCRIPTION OF THE INVENTION

Reference will now be made in detail to a preferred embodiment of the present invention.

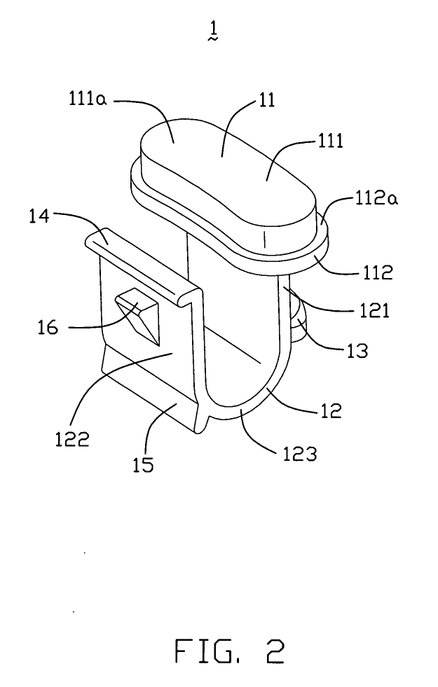

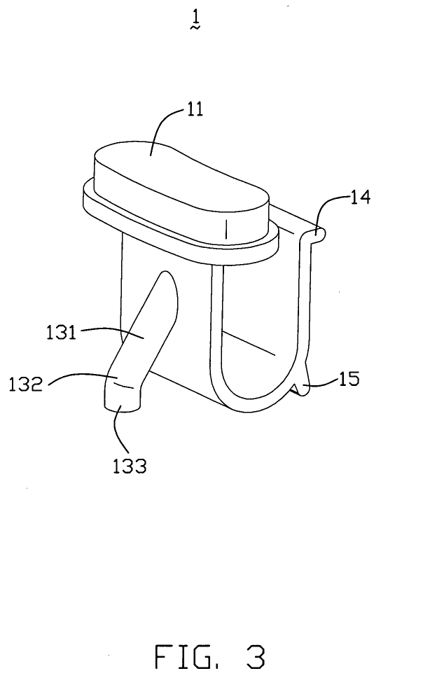

Reference to FIG. 2 and FIG. 3, perspective views of a fastening element 1 in accordance with a preferred embodiment in the electrical adapter box of the present invention are shown.

The fastening element 1 comprises a pushing portion 11, a U-shape transmitting portion 12 having an end connecting the pushing portion 11, a blocking portion 13 extending from one side of the transmitting portion 12, a first horizontal rib 14 extending from the other end of the transmitting portion 12, a second declining rib 15 and a triangle block 16 on the outside of the transmitting portion 12. The first rib 14 and the block 16 compose a fastening portion.

The pushing portion 11 comprises an upper first piece 111 and a lower second piece 112. The first piece 111 has a touching face 111a and the second piece 112 has a stopping face 112a larger than the touching face 111a. The transmitting portion 12 is made by plastic and is flexible. The transmitting portion 12 comprises a first vertical side wall 121 downwardly extending from the second piece 112, a second side wall 122 parallel to the first side wall 121 and an arc third wall 123 connecting the first side wall 121 and the second side wall 122 to form the bottom of the U-shape transmitting portion 12. The blocking portion 13 outward extends from the first side wall 12 and comprises a declining first section 131, a third vertical section 133, and a bend second section 132 connecting the first section 131 and the third section 133. The second rib 15 outward extends from the joint of the second side wall 122 and the third wall 123 to form an obtuse angle with the second side wall 122, and the length of the second rib 15 equal to the width of the second side wall 122. The block 16 is on the outside of the second side wall 133 and lower than the first rib 14 so that the receiving space is formed between the first rib 14 and the block 16.

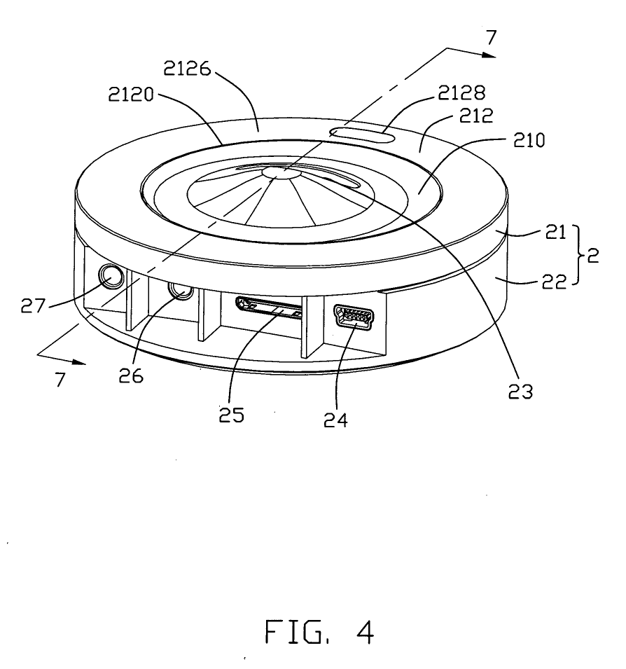

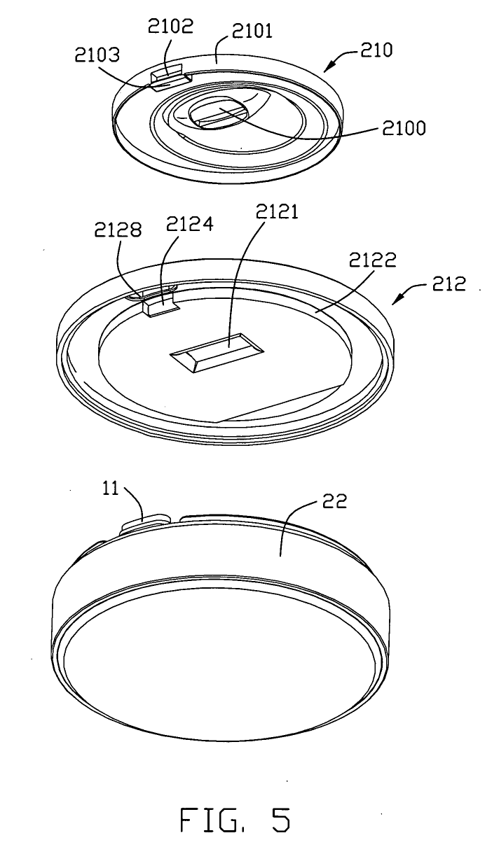

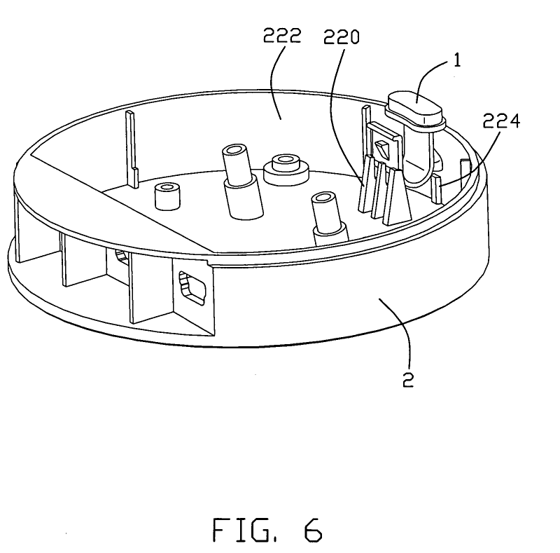

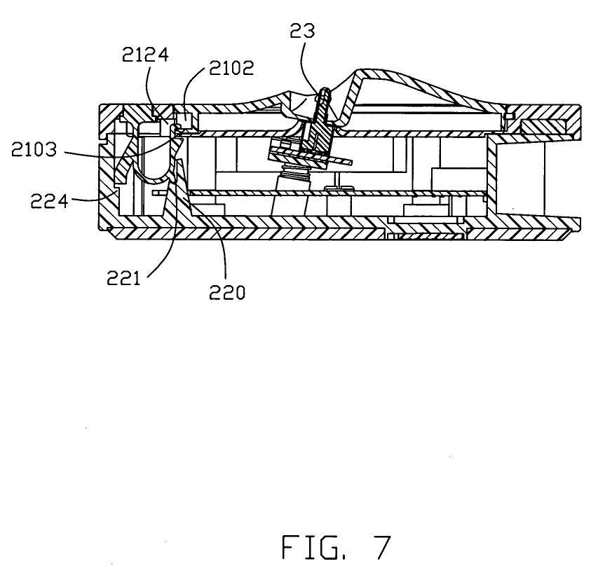

Reference to FIGS. 4-7, perspective views of an electrical adapter box 2 in accordance with a preferred embodiment of the present invention are shown.

The electrical adapter box 2 comprises a combined cover 21, a lower main body 22, a electric connector 23 below the combined cover 21 and some receiving hatches 24-27 connecting the interior and the exterior of the main body 22. In this embodiment, the electric connector 23 is fastened on the main body 22 and upward extends from the bottom of the main body 22 to form a mating portion below the combined cover 21 to connect electronic devices. The receiving hatch 24 is used to receive an electric connector to electrically connect electrical source (not shown). The receiving hatch 25 is used to receive an electric connector electrically connecting other electric devices (not shown) to transmit signals with data. The receiving hatches 26, 27 are used to receive electrical connectors to connect audio/video lines. In other embodiments, the receiving hatches 24-27 can receive different electric connectors by need. Electric connector 23 electrically connects the different electric connectors received in the receiving hatches 24-27 through wires (not shown) to achieve needed functions. The main body 22 comprises a receiving space and a wrapping wall 222 around the receiving space. The combined cover 21 comprises a first upper cover 210 and a second lower cover 212. The second cover 212 has a receiving space 2120 to receive the first cover 210 and an upper loop surface 2126. A pair of cutout 2100, 2121 are respectively formed on the first cover 210 and the receiving space 2120 of the second cover 212. The two cut out 2100, 2121 cooperate to each other to form a passage for other electric connectors of the electric devices. A cutout 2128 is in the loop surface 2126 and has certain length and width to receive the first piece 111 of the pushing portion 11 and not to receive the second piece 112. The first cover 210 has a loop wall 2101 and a notch 2102 rearward extends from the loop wall 2101 to form a lower wall 2103. The lower wall 2103 has a certain height corresponding to the height of the receiving space between the first rib 14 and the block 16.

The main body 22 comprises some post 220 to fix the fastening element 1 and a blocking pole 224 connecting the wrapping wall 222. A group of receiving grooves 221 formed on the post 220 arrange in a line to receive the second rib 15 of the fastening element 1.

In assembly, the combined cover 21 is assembled on the main body 22. The first rib of the fastening element 1 is received in the receiving grooves 221 of the post 220. The blocking portion 13 touches the wrapping wall 222 and is above the blocking pole 224. The first rib 14 inserts into the notch 2102 of the first cover 210 and the lower wall 2103 fills the receiving space between the first rib 14 and the block 16 in. Thus, the lower wall 2103 is below the first rib 14 and the first cover 210 and the second cover 212 are assembled together through the first rib 14.

In disassembly, the pushing portion is forced to downwards move, and the blocking portion downwards moves. At the same time, the first rib 14 removes from the combined cover 21 to expose in the receiving space of the main body 22 when the post 20 is supporting the fastening element 1 through the second rib 15. Thus, the first cover 210 can be parted from the second cover 212. For avoiding pushing portion 11 of the fastening element 1 from being pressed into the receiving space of the main body 22, the blocking pole 224 has a certain height to block the blocking portion 13 of the fastening element 1. Thus, when the force released, all components of the fastening element 1 could go back original places.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

What is claimed is:

1. An electrical adapter box, comprises
a combined cover comprising a first upper cover and a second lower cover;
a main body comprising a receiving space to receive some electric connectors and some posts; and
a fastening element comprising a pushing portion whose touching face faces to the exterior of the electrical adapter box, a fastening portion assembled to the combined cover without outside force, and an axis be supported by said posts;
wherein each of the first and second cover respectively have a cutout, said two cutout substantially aligned with each other, and said fastening portion removes with a support formed by said axis under outside force.

2. The electrical adapter box as claimed in claim 1, wherein said fastening portion comprises a first upper rib and a lower block apart from the first rib to form a receiving space.

3. The electrical adapter box as claimed in claim 1, wherein said fastening element also comprises a U-shape transmitting portion, which comprises a first side wall, a second side wall, and an arc wall connecting the first side wall and the second side wall.

4. The electrical adapter box as claimed in claim 3, wherein said first side wall downward extends from the pushing portion and said first rib connects the second side wall.

5. The electrical adapter box as claimed in claim 3, wherein said axis of the fastening element is a second rib extending from the joint of the second side wall and the arc wall to support.

6. The electrical adapter box as claimed in claim 5, wherein said main body also comprises some posts arranging in a line and each post has a receiving groove to receive the second rib.

7. The electrical adapter box as claimed in claim 1, wherein said pushing portion comprises an upper first piece and a lower second piece, the second piece has a stopping face larger than the touching face.

8. The electrical adapter box as claimed in claim 7, wherein said second cover comprises a loop surface with a cutout, the cutout has certain length and width to receive the first piece of the pushing portion and not to receive the second piece.

9. The electrical adapter box as claimed in claim 1, wherein said fastening portion also comprises a blocking portion outward extending from the first side wall and comprising a declining first section, a third vertical section, and a bend second section connecting the first section and the third section.

10. The electrical adapter box as claimed in claim 9, wherein said main body comprises a wrapping wall and a stopping pole connecting to the wrapping wall, said stopping pole is below the blocking portion to limit the removing range.

11. The electrical adapter box as claimed in claim 10, wherein said and two section and third section of the blocking portion are touching the wrapping wall above the stopping pole, and the wrapping wall provides a supporting force to the fastening element.

12. An electrical adaptor box comprising:
a main body defining a space with at least one connector mounted therein;
a cover sub-assembly including a lower cover and an upper cover, said lower cover directly mounted unto the main body and defining a first opening upwardly exposing said connector, said upper cover directly mounted unto the lower cover and defining a second opening essentially aligned with the first opening so as to upwardly expose said connector;
a fastening element supported upon the main body with an up-and-down moveable pushing portion upwardly exposed upon the lower cover and a reliable latching portion latchably engaged with the upper cover; wherein downward pushing the pushing portion may release the latching portion from the upper cover so as to allow upward movement of said upper cover away from the lower cover.

13. The adaptor box as claimed in claim 12, wherein said fastening element defines a rib at a lower portion functioning as a lever pivot between the pushing portion and the latching portion.
